(19) United States
(12) Patent Application Publication
(10) Pub. No.: US 2010/0130177 A1
(43) Pub. Date: May 27, 2010

(54) Methods and Apparatuses for Providing Carrier Selection on Display Capable Devices

(76) Inventors: Bernard Ku, Austin, TX (US); Armstrong Soo, San Ramon, CA (US)

Correspondence Address: AT&T Legal Department - PK;Attn: Patent Docketing, One AT&T Way, Room 2A-207, Bedminster, NJ, 07921, US

(21) Appl. No.: 12/276,759

(22) Filed: Nov. 24, 2008

(51) Int. Cl. H04M 3/42

(52) U.S. Cl. 455/414.1

(57) ABSTRACT

Systems and methods for providing carrier selection functionality for communications devices are disclosed. A bidding server can include a memory and a processor, and can interface with a network node and a device. The network node can include a proposal generator, a network monitor, and/or another network node. A proposal generator can include a processor and a memory, and can interface with a network monitor, a bidding server, a device, and/or other network nodes. When carrier selection functionality is requested, the requested communication details can be passed to a bidding server and/or a proposal generator. Rules, preferences, and/or network status can be evaluated to determine a proposal from one or more carriers and/or networks. The proposals can be passed to a bidding server and/or the device, displayed, a selection can be made by the device and/or a user. The device can be connected via the selected service.

### TECHNICAL FIELD

The present disclosure relates generally to mobile telephony and, more particularly, to methods and apparatuses for providing carrier selection on display capable devices.

### BACKGROUND

Customers may purchase communication services in pre-paid or post-paid arrangements. For example, cellular telephone users may purchase cellular telephone service in post-paid arrangements wherein a customer enters into a contract with a service provider for service. The user typically selects a plan and pays a set fee for the plan, which can include a designated number of minutes, a designated number of text messages that the user can send and/or receive without paying additional fees, and/or data connectivity and a designated amount of data transfer. In some arrangements, unlimited amounts of voice, text, and data transfer are included in a designated fee. If a customer uses less than the allotted limits of network resources during the designated time period, the unused time, data allowance, or text messaging allowance may be lost, added to a rolling account, or otherwise disposed of. If a customer exceeds the allotted limits of network resources during the designated time period, a flat rate, surcharge, or other fee can be added to the customer's bill.

Similarly, customers may purchase wired telephone and/or data services in post-paid arrangements wherein the customer selects a plan and agrees to pay a corresponding fee for the service. The fee is typically static, unless the customer uses the services to access network resources that are outside of the customer's selected plan, as briefly mentioned above, in which case surcharges or other fees may be added to the customer's bill.

In pre-paid arrangements, customers may pay for a designated amount of data transfer, voice calls, “air time,” or the like. The user can use the designated amount of network resources when and how he or she sees fit, without regard for time limitations, other than expiration dates and the like. Some customers prefer pre-paid arrangements since the budget for the associated communications is set in advance, which can reduce the likelihood of unanticipated charges for services.

In general, a user selects a carrier and purchases a set amount of time or enters into a long term contract with the carrier. Contracts may last for years, after which the customer is free to move to a new carrier without penalty. There is often a set-up or activation fee associated with selecting a new carrier for a communications service.

### SUMMARY

An embodiment of the present disclosure is directed to a method for providing a proposal to a device operating on a communications network. The method can include the steps of recognizing received data as a communication request received from the device. The communication request can include data that indicates a requested communication and a request for a proposal for providing the requested communication. The method can include acquiring a proposal for the requested communication. The proposal can include a charge for providing the requested communication, and an indication of the network resource that will provide the requested communication. The proposal can be sent to the device. The device, or a user of the device, can evaluate the proposal alone, or in combination with other proposals, and decide whether or not to accept the proposal. If the device, or the user of the device, accepts the proposal, the device can connect to the network resource associated with the proposal.

In some embodiments, acquiring the proposal includes sending a proposal request to a proposal generator and receiving a proposal from the proposal generator. In some embodiments, acquiring the proposal includes generating the proposal based, at least partially, upon analysis of the data indicating the requested communication using proposal analysis data.

In some embodiments, generating the proposal includes accessing a rule for determining the charge for the requested communication and for determining the network resource that will provide the requested communication. In some embodiments, generating the proposal includes accessing network resource status information. The network status information can be used for determining the charge for the requested communication, for determining the network resource that will provide the requested communication, and for determining availability of the network resource. In some embodiments, generating the proposal further includes accessing network resource status information for determining a quality of service (QoS) for the communication. As such, in some embodiments, the proposal can further include a guaranteed QoS for the communication.

In some embodiments, sending the proposal to the device includes sending the proposal to a mobile communications device operating on a communications network. For example, the mobile communications device can include a cellular telephone handset, and the communications network can include a cellular communications network. In some embodiments, sending the proposal to the device includes sending the proposal to a bidding server operating on a communications network.

Another embodiment of the present disclosure is directed to a method for generating a proposal for a requestor. The method can include recognizing received data as a proposal request received from the requestor. The proposal request can include data indicating a requested communication and a request for a proposal for providing the requested communication. The method can further include acquiring proposal analysis data for analyzing the proposal request to determine a charge for the requested communication and to determine a network resource that will provide the requested communication. The method also can include generating a proposal for the requested communication. The proposal can include the charge for providing the requested communication and an indication of the network resource that will provide the requested communication. The proposal can be sent to a requestor.

In some embodiments, acquiring the proposal analysis data includes accessing a rule to determine the charge for the requested communication and to determine the network resource that will provide the requested communication. In some embodiments, acquiring the proposal analysis data includes accessing network resource status information to determine the charge for the requested communication, to determine the network resource that will provide the requested communication, and to determine availability of the network resource.

In some embodiments, sending the proposal to the requestor includes sending the proposal to a mobile communications device operating on the first communications network. In some embodiments, sending the proposal to the requestor includes sending the proposal to a bidding server operating on a second communications network. In some embodiments, sending the proposal to the requestor includes sending the proposal to a proposal generator operating on a third communications network. In some embodiments, sending the proposal to the requester includes sending the proposal to a cellular telephone handset operating on a cellular communications network.

Another embodiment of the present disclosure is directed to a system for allowing a device operating on a communications network to select a network resource to use for a requested communication. The system can include the device and a bidding server in communication with the device. The device can include a device memory in communication with a device processor and a device network interface. The device memory can be configured to store instructions, executable by the device processor to cause the device to request a proposal from the bidding server, to recognize received data as a proposal sent from the bidding server, to select the proposal, and to connect to the network resource associated with the proposal. The device can connect to the network resource via the network interface. The proposal can include a charge for providing the requested communication and an indication of a network resource that will provide the requested communication.

In some embodiments, the instructions for recognizing received data further include instructions, executable by the device processor to cause the device to recognize received data as two or more proposals sent from the bidding server. Each of the two or more proposals can include a charge for providing the requested communication, and an indication of a network resource that will provide the requested communication.

In some embodiments, the system further includes a proposal generator for generating the proposal sent from the bidding server. The proposal generator can include a generator processor in communication with a generator memory. The generator memory can be configured to store instructions, executable by the generator processor to cause the proposal generator to acquire proposal analysis data for analyzing the proposal request to determine the charge for the requested communication and to determine the network resource that will provide the requested communication, to generate the proposal for the requested communication, and to send the proposal to the bidding server. The proposal can include the charge for providing the requested communication and an indication of the network resource that will provide the requested communication.

In some embodiments, the instructions stored in the generator memory for acquiring proposal analysis data further include instructions, executable by the generator processor to cause the proposal generator to acquire proposal analysis data including a rule. The rule can be used for determining the charge for the requested communication and for determining the network resource that will provide the requested communication.

In some embodiments, the instructions stored in the generator memory for acquiring proposal analysis data further include instructions, executable by the generator processor to cause the proposal generator to acquire proposal analysis data including network resource status information. The network resource status information can be used for determining the charge for the requested communication, for determining the network resource that will provide the requested communication, and for determining availability of the network resource.

In some embodiments, the instructions stored in the generator memory for acquiring proposal analysis data further include instructions, executable by the generator processor to cause the proposal generator to acquire proposal analysis data including network resource status information. The network resource status information can be used for determining the charge for the requested communication, for determining the network resource that will provide the requested communication, for determining availability of the network resource, and for determining a quality of service (QoS) for the communication. As such, the proposal can further include a guaranteed QoS for the communication.

In some embodiments, acquiring proposal analysis data can further include acquiring proposal analysis data including network resource status data that is acquired in real-time from a node of the communications network.

### BRIEF DESCRIPTION OF THE DRAWINGS

FIG. 1 schematically illustrates a system for providing carrier selection on display capable devices, according to an exemplary embodiment of the present disclosure.

FIG. 2 schematically illustrates an exemplary device with which embodiments of the present disclosure can be implemented, according to an exemplary embodiment of the present disclosure.

FIG. 3 schematically illustrates a bidding server, according to an exemplary embodiment of the present disclosure.

FIG. 4 schematically illustrates a proposal generator, according to an exemplary embodiment of the present disclosure.

FIG. 5 schematically illustrates a method for receiving communication requests and providing carrier selection functionality at a device, according to an exemplary embodiment of the present disclosure.

FIG. 6 schematically illustrates a method for requesting proposals, according to an exemplary embodiment of the present disclosure.

FIG. 7 schematically illustrates a method for generating a proposal, according to an exemplary embodiment of the present disclosure.

FIG. 8 schematically illustrates a flow diagram for providing carrier selection on display capable devices, according to an exemplary embodiment of the present disclosure.

FIG. 9 illustrates a graphical user interface (GUI) for providing a dialing application that includes carrier selection functionality, according to an exemplary embodiment of the present disclosure.

FIG. 10 illustrates a GUI for providing a carrier selection interface, according to an exemplary embodiment of the present disclosure.

### DETAILED DESCRIPTION

As required, detailed embodiments of the present disclosure are disclosed herein. It must be understood that the disclosed embodiments are merely exemplary examples of the disclosure that may be embodied in various and alternative forms, and combinations thereof. As used herein, the word “exemplary” is used expansively to refer to embodiments that serve as an illustration, specimen, model or pattern. The figures are not necessarily to scale and some features may be exaggerated or minimized to show details of particular components. In other instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

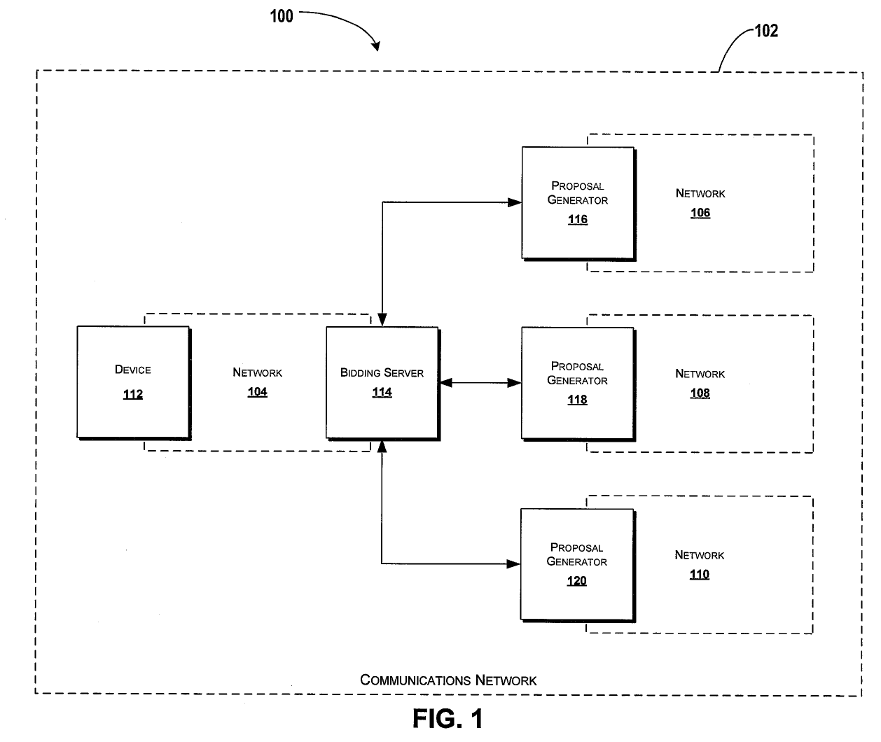

Referring now to the drawings in which like numerals represent like elements throughout the several views, FIG. 1 schematically illustrates a system 100 for providing carrier selection on display capable devices, according to an exemplary embodiment of the present disclosure. The system 100 can include a communications network 102. The communications network 102 can include two or more networks 104, 106, 108, 110. The networks 104, 106, 108, 110 can include one or more cellular networks, one or more packet data networks, for example, the Internet (Internet), one or more circuit switched network, for example, one or more publicly switched telephone networks (PSTN's), and/or other networks and devices. For purposes of illustration, and not limitation, the illustrated network 104 will be described as a cellular network, though the systems and methods described below can be performed on other networks including, but not limited to, the Internet, a PSTN, or another network.

The cellular network 104 can include various components such as, but not limited to, base transceiver stations (BTS's), Node-B's, base station controllers (BSC's), radio network controllers (RNC's), mobile switching centers (MSC's), short message service centers (SMSC's), multimedia messaging service centers (MMSC's), home location registers (HLR's), visitor location registers (VLR's), charging platforms, billing platforms, voicemail platforms, GPRS core network components, location service nodes, Internet protocol multimedia subsystem (IMS), and the like. The cellular network 104 also can include radios and nodes for receiving and transmitting voice, data, and combinations thereof to and from radio transceivers, networks, and the Internet.

The cellular network 104 can be configured as a 2G GSM (Global System for Mobile communications) network, and can provide data communications via GPRS (General Packet Radio Service) and EDGE (Enhanced Data rates for GSM Evolution). Additionally, the cellular network 104 can be configured as a 3G UMTS (Universal Mobile Telecommunications System) network and can provide data communications via the HSPA (High-Speed Packet Access) protocol family, for example, HSDPA (High-Speed Downlink Packet Access), EUL (Enhanced Uplink) or otherwise termed HSUPA (High-Speed Uplink Packet Access), and HSPA+(Evolved HSPA). The cellular network 104 is also compatible with future mobile communications standards including, but not limited to, pre-4G and 4G, for example. As illustrated in FIG. 1, a device 112 can be in communication with the cellular network 104.

The communications network 102 also can include a bidding server 114. In some embodiments, the bidding server 114 includes one or more hardware and/or software modules that reside upon, or are in communication with, a cellular network 104. In some embodiments, the bidding server 114 is a server operating on another network, for example, as a server on the Internet. The bidding server 114 can reside upon, or be in communication with, the communications network 102.

The bidding server 114 can be in communication with one or more proposal generators 116, 118, 120. The proposal generators 116, 118, 120 can reside upon, be associated with, or be in communication with, one or more networks, for example, the networks 106, 108, 110. The proposal generators 116, 118, 120 can include a combination of hardware and software. It should be understood that more than three proposal generators can exist in the system 100, and/or on the communications network 102, and that the proposal generators 116, 118, 120 can be substantially similar to one another.

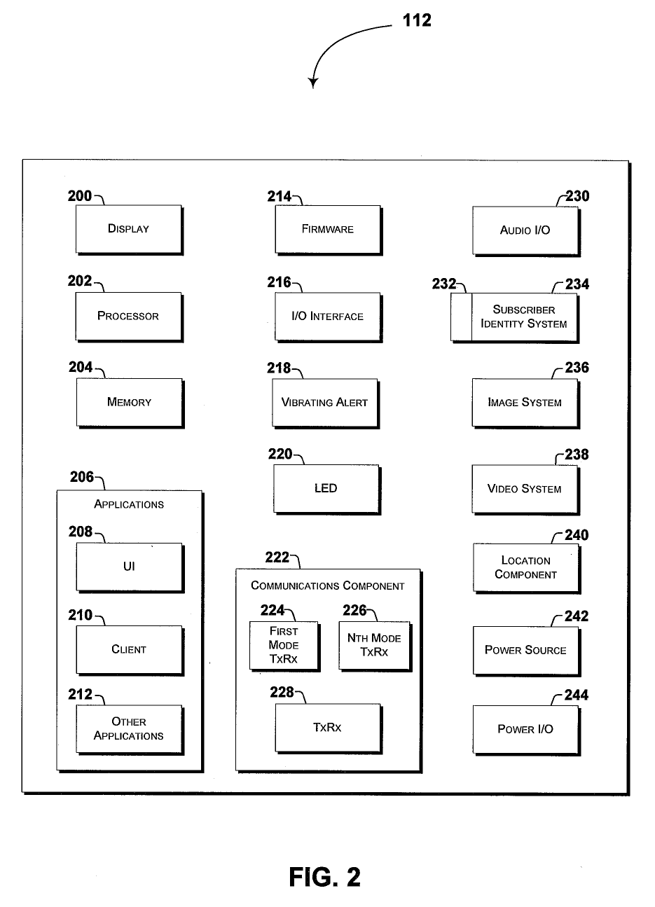

FIG. 2 illustrates a schematic block diagram of an exemplary device 112 for use in accordance with some exemplary embodiments of the present disclosure. Although no connections are shown between the components illustrated in FIG. 2, the components can interact with each other to carry out functions of the device 112.

It should be understood that FIG. 2 and the following description are intended to provide a brief, general description of a suitable environment in which the various aspects of some embodiments of the present disclosure can be implemented. While the description includes a general context of computer-executable instructions, the present disclosure also can be implemented in combination with other program modules and/or as a combination of hardware and software. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

The device 112 can be a multimode headset, and can include a variety of computer readable media, including volatile media, non-volatile media, removable media, and non-removable media. The term “computer-readable media” and variants thereof, as used in the specification and claims, can include storage media and communication media. Storage media can include volatile and/or non-volatile, removable and/or non-removable media such as, for example, RAM, ROM, EEPROM, flash memory or other memory technology, CD ROM, DVD, or other optical disk storage, magnetic tape, magnetic disk storage or other magnetic storage devices, or any other medium that can be used to store the desired information and that can be accessed by the device 112.

The device 112 can include a display 200 for displaying multimedia such as, for example, text, images, video, telephony functions such as Caller ID data, setup functions, menus, music, metadata, messages, wallpaper, graphics, Internet content, advertisements, device status, preferences settings, map data, navigation data, location data, and the like. The device 112 can include a processor 202 for controlling, executing, and/or processing data. A memory 204 can interface with the processor 202, and can store data. The data stored by the memory 204 can include, for example, applications 206.

The applications 206 can include, for example, carrier selection applications, navigation applications, web browsing software, text input software, mapping software, audio player software, video playback software, voicemail software, audio playback software, music player software, email software, messaging software, combinations thereof, and the like. The applications 206 also can include a user interface (UI) application 208. The UI application 208 can interface with a client 210 (e.g., an operating system) to facilitate user interaction with device functionality and data, for example, answering/initiating calls, accepting/outputting navigation data, entering/deleting data, configuring settings, address book manipulation, multimode interaction, and the like. The applications 206 also can include other applications 212 such as, for example, firmware, navigation software, visual voicemail software, add-ons, plug-ins, voice processing, voice recording, messaging, e-mail processing, video processing, image processing, archival applications, music playback, combinations thereof, and the like, as well as subsystems and/or components. The applications 206 can be stored in the memory 204 and/or in a firmware 214 as executable instructions, and can be executed by the processor 202. The firmware 214 also can store code for execution during initialization of the device 112.

An input/output (I/O) interface 216 can be provided for input/output of data and/or signals. The I/O interface 216 can be a hardwire connection, such as, for example, a USB port, a mini-USB port, an audio jack, a PS2 port, an IEEE 1394 port, a serial port, a parallel port, an Ethernet (RJ48) port, a telephone (RJ11) port, and the like, and can accept other I/O devices such as, for example, keyboards, keypads, mice, interface tethers, stylus pens, printers, thumb drives, touch screens, multi-touch screens, touch pads, trackballs, joy sticks, microphones, remote control devices, monitors, displays, liquid crystal displays (LCD's), combinations thereof, and the like. It should be appreciated that the I/O interface 216 can be used for communications between the device and a network or local device.

The device 112 can include a vibrating alert 218 for providing a vibration alert function for the device 112. The device 112 also can include one or more light emitting diodes 220 (LED's) for providing device status information, visual alerts, warnings, and the like.

A communications component 222 can interface with the processor 202 to facilitate wired/wireless communications with external systems including, for example, bidding servers 114, proposal generators 116, 118, 120, cellular networks, location systems, VoIP networks, local area networks (LAN's), wide area networks (WAN's), metropolitan area networks (MAN's), personal area networks (PAN's), and other networks, which can be implemented using WIFI®, WIMAX™, combinations and/or improvements thereof, and the like. The communications component 222 can be used instead of, or in addition to, the I/O interface 216. The communications component 222 also can include a multimode communications subsystem for providing cellular communications via different cellular technologies.

For example, a first cellular transceiver 224 can operate in one mode, for example, GSM, and an Nth transceiver 226 can operate in a different mode, for example UMTS. Although only two transceivers 224, 226 are illustrated, it should be appreciated that more than two transceivers can be included in the device 112. The communications component 222 also can include a transceiver 228 for unlicensed communications using technology such as, for example, WIFI®, WIMAX™, BLUETOOTH®, infrared, infrared data association (IRDA), near field communications (NFC), other radio frequency (RF) applications, and the like. The communications component 222 also can facilitate communications reception from terrestrial radio networks, digital satellite radio networks, Internet-based radio services networks, combinations thereof, and the like. The communications component 222 can process data from a network such as, for example, the Internet, a corporate intranet, a home broadband network, and the like, via an internet service provider (ISP), a digital subscriber line (DSL) provider, a cable provider, and/or a broadband provider.

Audio capabilities can be provided by an audio I/O component 230 that can include a speaker for the output of audio signals and a microphone to collect audio signals. The audio I/O component 230 can include more than one speaker, including, for example, an earpiece speaker, a loudspeaker, a ringer, and the like. The device 112 can include a slot interface 232 for accommodating a subscriber identity system 234 such as, for example, a SIM or universal SIM (USIM). The subscriber identity system 234 instead can be manufactured into the device 112, thereby obviating the need for a slot interface 232. In some embodiments, the subscriber identity system 234 can store certain features, account information, user information, rules, policies, models, and the like. The subscriber identity system 234 can be programmed by a manufacturer, a retailer, a customer, a network operator, and the like.

The device 112 can include an image capture and processing system 236 (image system). Photos and/or videos can be obtained via an associated image capture subsystem of the image system 236, for example, a camera. The device 112 also can include a video system 238 for capturing and recording video content. The video system 238 can provide video data to various applications 206, such as, for example, video teleconferencing applications, video compression applications, video messaging applications, video sharing applications, and the like.

A location component 240, can be included to send and/or receive signals such as, for example, GPS data, A-GPS data, WIFI®, WIMAX™, cellular network triangulation data, and/or combinations thereof, and the like. The location component 240 can interface with cellular network nodes, telephone lines, satellites, location transmitters and/or beacons, wireless network transmitters and receivers, for example, WIFI® hotspots, radio transmitters, combinations thereof, and the like. The device 112 can obtain, generate, and/or receive data to identify its location, or can transmit data used by other devices to determine the device 112 location. The device 112 can include a power source 242 such as batteries and/or other power subsystems (AC or DC). The power source 242 can interface with an external power system or charging equipment via a power I/O component 244.

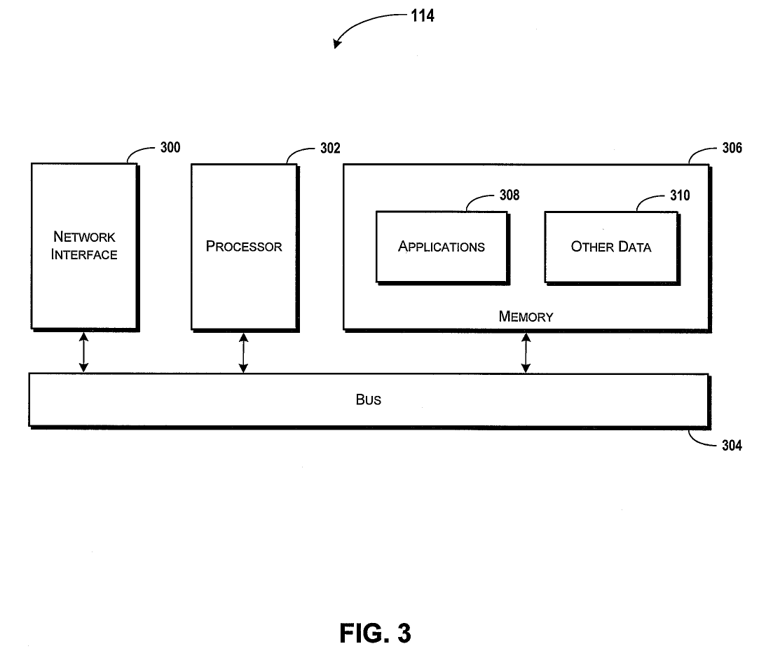

FIG. 3 schematically illustrates a block diagram of a bidding server 114 according to an exemplary embodiment of the present disclosure. The bidding server 114 can be a combination of hardware and software, and can exist as a node upon, or in communication with, the communications network 102, as explained above with reference to FIG. 1. The bidding server 114 can be in communication with multiple networks, e.g., the networks 104, 106, 108, 110, and/or with device such as, for example, the device 112, the proposal generators 116, 118, 120, and/or other network nodes via one or more network interfaces 300.

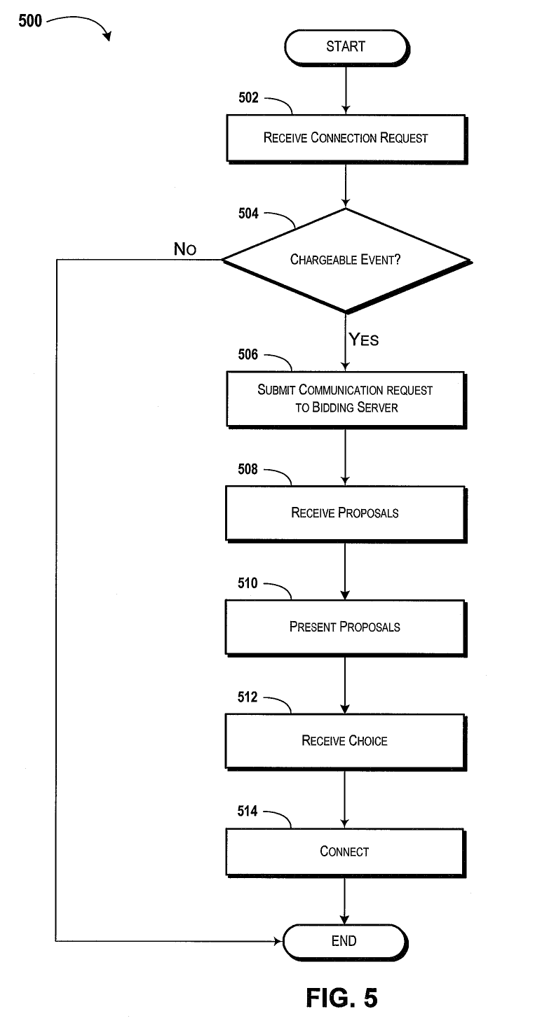

The network interfaces 300 can be operatively linked and in communication with one or more processors 302 via one or more data/memory busses 304. The network interface 300 can be used to allow the bidding server 114 to communicate with the device 112 and/or the other devices and networks including various additional and/or alternative components of the communications network 102, and/or any device connected thereto or residing thereon, as explained above. The processor 302 can be operatively linked and in communication with one or more memory devices 306 via the data/memory bus 304. The processor 302 can execute instructions to perform various functions. Execution of the instructions can cause the bidding server 114 to perform various functions, for example, the functionality of the bidding server 114 described in FIGS. 5-10.

The word “memory,” as used herein to describe the memory 306, collectively includes all memory types associated with the bidding server 114 such as, but not limited to, processor registers, processor cache, random access memory (RAM), other volatile memory forms, and non-volatile, semi-permanent or permanent memory types; for example, tape-based media, optical media, flash media, hard disks, combinations thereof, and the like. While the memory 306 is illustrated as residing proximate the processor 302, it should be understood that the memory 306 can be a remotely accessed storage system, for example, a server and/or database on the communications network 102, a remote hard disk drive, a removable storage medium, combinations thereof, and the like. Moreover, the memory 306 is intended to encompass network memory and/or other storage devices in wired or wireless communication with the bidding server 114, which may utilize the network interface 300 to facilitate such communication. Thus, any of the data, applications, and/or software described below can be stored within the memory 306 and/or accessed via network connections to other data processing systems (not shown) that may include a local area network (LAN), a metropolitan area network (MAN), or a wide area network (WAN), for example.

Accordingly, concepts of the present disclosure may operate on the bidding server 114, wherein the bidding server 114 is configured as a server to one or more client data processing systems as dictated by a client/server model. The illustrated memory 306 can include one or more applications 308 and/or other data 310.

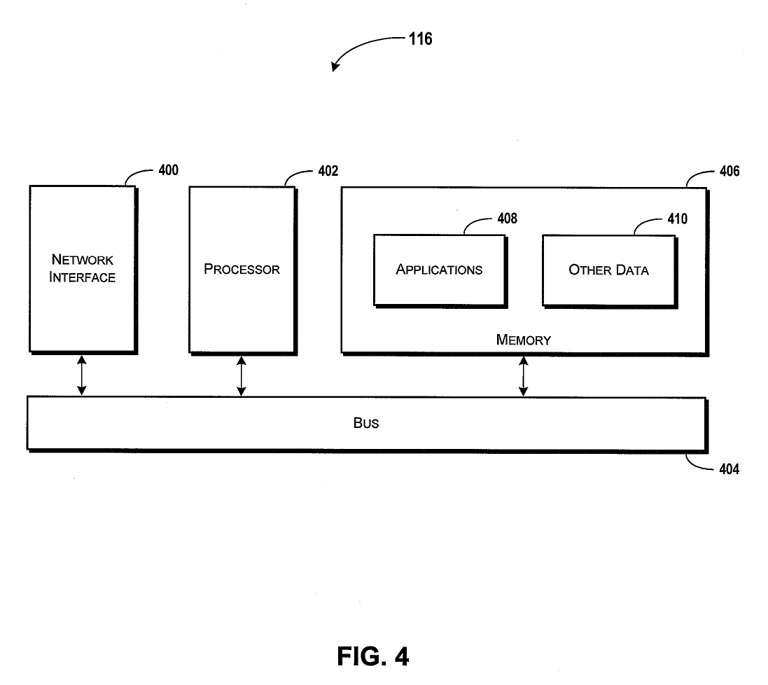

The applications 308 can include various programs, routines, subroutines, algorithms, software, tools, and the like (“instructions”), for providing carrier selection functionality to a user of the device 112. For example, the applications 308 can be used to recognize data received from the device 112 as communication information for which bidding is requested. The applications 308 can also include instructions for sending the communication information to one or more proposal generators 116, 118, 120, receiving proposals from the proposal generators, and sending the proposals to the device 112. The applications 308 also can include instructions for formatting communication requests and proposals, and passing user input to other networks and/or network elements. These and other functions of the bidding server 114 will be described in more detail below with reference to FIGS. 4-10.

The applications 308 also can include instructions used to operate the bidding server 114 and/or devices connected to the bidding server 114, if any. The instructions can include, for example, operating systems, firmware, drivers for peripherals, and the like. The applications 308 also can include, for example, authentication software, billing applications, interactive voice response systems (IVR's), user interface (UI) applications, usage tracking applications, and the like.

The other data 310 can include, for example, billing information, roaming partner lists, Internet Protocol (IP) addresses of proposal generators, charging applications, account data, user device data, software, programs, algorithms, hardware data, carrier rules, rate tables, and the like. The other data 310 also can include account/device data that relates to a user's account and/or to one or more devices 112. The account/device data can include, but is not limited to, the user's subscription plan, subscription features, user preferences, and/or the capabilities of the user's device 112.

The bidding server 114 can be in communication with one or more charging platforms, subscriber databases, and/or other network nodes, to receive the account/device data relating to a user's subscription plan, usage, and charging and/or billing information. Additionally, the account/device data can inform the bidding server 114 of the features the user's device 112 supports by examining data relating to the device 112, for example, one or more of the IMSI or the IMEI, the serial number, a carrier, a software version(s), firmware information, one or more carrier-specific applications, combinations thereof, and the like. As such, the account device data can indicate if the device 112 supports WIFI®, 3G, 2G, EDGE, GPS, A-GPS, short message service (SMS) messaging, email messaging, data transfer services, network triangulation, BLUETOOTH®, NFC, audible navigation instructions, web formats, audio formats, video formats, data transfer of audio files and video files, and the like. Additionally, the account/device data can indicate whether services for the device 112 are charged/billed on a pre-paid and/or post-paid basis, or if features are available on the device 112.

The account/device data can pass-through the bidding server 114, or can be stored, at least temporarily, by the bidding server 114. Additionally, billing, privacy, safety, and/or other concerns can be used to tailor functionality of the bidding server 114 through the account/device data. For example, a user can disable the functionality of the bidding server 114 and store a preference indicating disablement of the bidding server 114 as an account setting stored in the account/device data. Additionally, the bidding server 114 can use billing information to adjust functionality of the bidding server 114. For example, a notification can be sent from a billing platform to the bidding server 114 and the bidding server 114 can disable and/or enable functionality, place limits on bidding amounts, and the like, automatically. A user can be given the ability to override deactivation of some, none, or all desired features and/or functionality of the bidding server 114.

The other data 310 also can include a charging module (not illustrated) that can be used to track, collect, and/or report activities of the bidding server 114 to a charging and/or billing system at the bidding server 114, or elsewhere on the communications network 102 for charging and/or billing purposes. The charging module can track, for example, how much data is sent and received by the bidding server 114, and can report this information to a charging and/or billing system of the communications network 102, for example. Charging and/or billing can be pre-paid or post-paid. The functionality of the bidding server 114 can be charged on any desired basis, including, but not limited to, a per-use basis, as a flat fee, as part of service package, or the like.

Although not illustrated in FIG. 3, the applications 308 can also include verification modules. The verification modules can review data submitted for bidding, proposals received from proposal generators 116, 118, 120, and the like. The verification modules can perform various analyses on the data to determine, for example, the likelihood that the data was entered correctly, that quality of service (QoS) commitments are manageable, that the quoted rates and/or fees are in-line with typical rates and/or fees, that infrastructure exists for completing the requested communications, and the like. These and other functions will be described in more detail below.

FIG. 4 schematically illustrates a block diagram of a proposal generator 116 according to an exemplary embodiment of the present disclosure. It should be understood that the illustrated proposal generator 116 is merely exemplary of a proposal generator, and that the proposal generators 116, 118, 120 can be substantially similar in basic structure and functionality. The proposal generator 116 can be a combination of hardware and software, and can exist as a node upon, or in communication with, the communications network 102, as explained above with reference to FIG. 1. The proposal generator 116 can be in communication with multiple networks 104, 106, 108, 110 and/or devices such as, for example, the device 112 and the bidding server 114, via one or more network interfaces 400.

The network interfaces 400 can be operatively linked and in communication with one or more processors 402 via one or more data/memory busses 404. The network interface 400 can be used to allow the proposal generator 116 to communicate with the bidding server 114 and/or nodes and devices and networks including various additional and/or alternative components of the network 106, the communications network 102, and/or any device connected thereto or residing thereon. The processor 402 can be operatively linked and in communication with one or more memory devices 406 via the data/memory bus 404.

The word “memory,” as used herein to describe the memory 406, collectively includes all memory types associated with the proposal generator 116 such as, but not limited to, processor registers, processor cache, random access memory (RAM), other volatile memory forms, and non-volatile, semi-permanent or permanent memory types; for example, tape-based media, optical media, flash media, hard disks, combinations thereof, and the like. While the memory 406 is illustrated as residing proximate the processor 402, it should be understood that the memory 406 can be a remotely accessed storage system, for example, a server and/or database on the communications network 102, a remote hard disk drive, a removable storage medium, combinations thereof, and the like. Moreover, the memory 406 is intended to encompass network memory and/or other storage devices in wired or wireless communication with the proposal generator 116, which may utilize the network interface 400 to facilitate such communication. Thus, any of the data, applications, and/or software described below can be stored within the memory 406 and/or accessed via network connections to other data processing systems (not shown) that may include a local area network (LAN), a metropolitan area network (MAN), or a wide area network (WAN), for example.

Accordingly, concepts of the present disclosure may operate on the proposal generator 116, wherein the proposal generator 116 is configured as a server to one or more client data processing systems as dictated by a client/server model. The illustrated memory 406 can include one or more applications 408 and/or other data 410.

The applications 408 can include various programs, routines, subroutines, algorithms, software, tools, and the like (“instructions”). The applications 408 can be executed by the processor 402 to cause the proposal generator 116 to perform various functions including, but not limited to, generating proposals for a bidding server 114. For example, the applications 408 can be used to recognize data received from the bidding server 114 as bidding information for which a proposal is solicited by the bidding server 114. The applications 408 can also include instructions for sending the generated proposals to the bidding server 114, soliciting proposal details and/or network traffic information from network nodes and/or elements, formatting proposals, verifying proposals information, and the like. The applications 408 can also be executed to cause the proposal generator 116 to acquire network information to use in generating proposals. These and other functions of the proposal generator 116 will be described in more detail below with reference to FIGS. 5-10.

The applications 408 also can include instructions used to operate the proposal generator 116 and/or devices connected to the proposal generator 116, if any. The instructions can include, for example, operating systems, firmware, drivers for peripherals, and the like. The applications 408 also can include, for example, authentication software, billing applications, interactive voice response systems (IVR's), user interface (UI) applications, usage tracking applications, and the like.

The other data 410 can include, for example, rules, billing information, roaming partner lists, rate lists, QoS standards, Internet Protocol (IP) addresses of bidding servers 114, billing applications, software, programs, algorithms, hardware data, and the like. The proposal generator 116 can be in communication with one or more billing platforms, and/or other network nodes, to receive the account/device data relating to a user's subscription plan, usage, and billing information.

Similarly, the proposal generator 116 can include, or can be in communication with, one or more network traffic monitors to determine current network loads, rates, QoS levels, combinations thereof, and the like. The proposal generator 116 can use the information from the network traffic monitors to determine rates, QoS commitments, connection times, and the like, to consider in formulating a proposal for the bidding server 114.

The other data 410 also can include a charging module (not illustrated) that can be used to track, collect, and/or report activities of the proposal generator 116 to a charging and/or billing system at the proposal generator 116, or elsewhere on the communications network 102 for charging and/or billing purposes. The charging module can track, for example, how much data is sent and received by the proposal generator 116, and can report this information to a charging and/or billing system of the communications network 102, for example. Charging and/or billing can be pre-paid or post-paid. The functionality of the proposal generator 116 can be charged on any desired basis, including, but not limited to, a per-use basis, as a flat fee, as part of service package, or the like.

Although not illustrated in FIG. 4, the applications 408 can also include verification modules, as discussed briefly above. The verification modules can review data received from network elements, the bidding server 114, and generated by the proposal generator 116, for example. The verification modules can perform various analyses on the data to determine, for example, the likelihood that the data was received correctly, that quality of service (QoS) commitments are manageable, that rate information is accurate and up-to-date, and the like. These and other functions will be described in more detail below.

FIG. 5 schematically illustrates a method 500 for sending a connection request to a bidding server, according to an exemplary embodiment of the present disclosure. It should be understood that the steps of the method 500 are not necessarily presented in any particular order and that performance of some or all the steps in an alternative order(s) is possible and is contemplated. The steps have been presented in the demonstrated order for ease of description and illustration. Steps can be added, omitted and/or performed simultaneously without departing from the scope of the appended claims. It should also be understood that the illustrated method 500 can be ended at any time. Some or all steps of this process, and/or substantially equivalent steps, can be performed by execution of computer-readable instructions included on a computer readable medium.

The method 500 begins, and flow proceeds to block 502, wherein a connection request is received at the device 112. The connection request can include, for example, a telephone number, a data session request, and the like, initiated at the device 112. As illustrated at block 504, the device 112 can determine if the requested communication is a chargeable event. For purposes of the description and the claims, the term “chargeable event” includes voice services, data services, carrier selection services, and/or other communications that will incur a charge if initiated by the user at a particular time including, but not limited to, carrier selection functionality, voice calls, data sessions, SMS services, MMS services, navigation services, voicemail services, email services, and the like. The example of a voice call is used for purposes of illustration, not limitation.

In some embodiments, the device 112 can be configured to send data relating to the requested communication (“communication request”) to a bidding server 114 when a communication request that is recognized as a chargeable event is requested or occurs at the device 112, as illustrated at block 506. In some embodiments, all communication requests entered at the device 112 pass through or to a bidding server 114 prior to connection, and the bidding server 114 determines if the communication request is a chargeable event. In some embodiments, the device 112 sends connection data to the bidding server 114 when a requested communication is recognized as a chargeable event.

For purposes of illustration, and not limitation, a chargeable event can be recognized by the device 112 and/or the bidding server 114 based upon the number dialed, a user preference, request of a data source, information received by a network element during attempted connection, user input, and the like. For example, a user can enter an international phone number at the device 112. Upon attempted connection, a network node, or the bidding server 114, can recognize the phone number as an international number based upon, for example, area codes, international exchanges, dialing prefixes, and the like. The bidding server 114, or other network node, can inform the device 112 and/or a bidding server 114.

Additionally, or alternatively, a user can request a network resource that exceeds, or is not included in, a user's plan. For example, if a user requests a data session using an account that does not include data connectivity, the network can recognize the data session as a chargeable event.

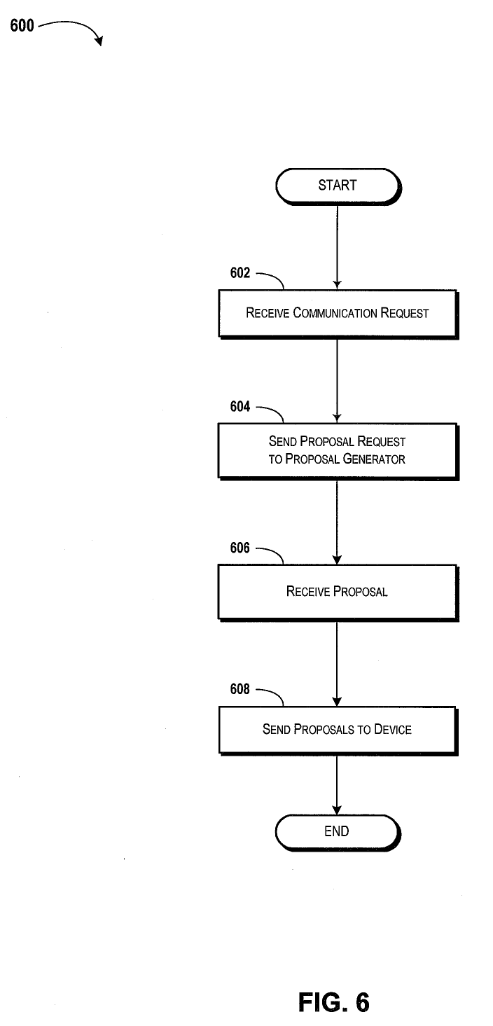

If the communication request is recognized as chargeable event, the device 112 can send data relating to the communication request to the bidding server 114. The bidding server 114 can send proposal requests to one or more proposal generators 116, 118, 120, solicit and receive proposals from the proposal generators 116, 118, 120, and format bids and transfer the bids to the device 112, as will be explained in more detail below with reference to FIG. 6. Additionally, or alternatively, the bidding server 114 can store rules and/or can connect to one or more network nodes to retrieve rules and/or network information. The bidding server 114 can use the information to generate the proposals, as will be explained in more detail below.

At block 508, the device 112 can receive one or more proposals for the requested service. In some embodiments, the proposals, or bids, include data that indicates the guaranteed QoS, rates for the requested communication, carrier information, connection times, connection fees, transfer rates, combinations thereof, and the like. Rates and/or connection fees can include connection charges, per minute charges, per byte charges, flat fees, per message fees, and the like. It should be understood that rates can be equal to zero, i.e., certain services can be offered free of charge if obtained via a carrier selection application. In fact, some embodiments include offering free communications as promotions to entice customers to try network services offered by a carrier and/or operated on a network. As such, a “charge” and a “rate,” as used in the specification and claims, includes charges of $0.00.

At block 510, the device 112 can present the proposals to a user, or to an application, for selection of the desired service. The determination as to which service to use can be made by prompting a user for input, for example, by asking a user to select which of the presented proposals he or she wants to use. Additionally, or alternatively, a user can store one or more preferences in a device setting and/or account setting associated with a carrier selection application. The carrier selection application can determine which service to use based upon the preferences. For example, a preference can specify a minimum or maximum QoS, a minimum or maximum rate and/or price, a preferred carrier, and the like, and the carrier selection application can prioritize selection of the service based, at least partially, upon these preferences. The preference can be stored at the device 112, the bidding server 114, or elsewhere on the communications network 102, and can be communicated to the carrier selection application. The device 112 can receive a service choice, as illustrated at block 512.

As illustrated at block 514, the device 112 can connect to the selected service. In some embodiments, the device 112 contacts the bidding server 114 with its service choice, and the bidding server 114 instructs the device 112 how to commence the requested communication. In some embodiments, connection information can be passed to the device 112 as part of the proposals, and selection of a proposal can instruct a device 112 to connect to the requested service. In some embodiments, the device 112 contacts the bidding server 114 with data that indicates the selected service, and the bidding server 114 creates a connection allowing the device 112 to communicate via the selected service. In some embodiments, the device 112 is directed to contact a designated entity that initiates the requested service. The entity can be the bidding server 114, a node on a network that provides the selected service, or a connection server operating on the communications network 102. Other embodiments are possible, and contemplated.

Returning briefly to block 504, if the device 112 does not recognize a chargeable event, the communication can proceed according to other processes, for example, a default communication handling process. The method 500 can end.

FIG. 6 schematically illustrates a method 600 for generating a proposal request, according to an exemplary embodiment of the present disclosure. It should be understood that the steps described are not necessarily presented in any particular order and performance of some or all the steps in an alternative order(s) is possible and is contemplated. The steps have been presented in the demonstrated order for ease of description and illustration. Steps can be added, omitted and/or performed simultaneously without departing from the scope of the appended claims. Some or all steps of this process, and/or substantially equivalent steps, can be performed by execution of computer-readable instructions included on a computer readable medium.

The method 600 begins, and flow proceeds to block 602, wherein a bidding server 114 receives a communication request. For example, the bidding server 114 can receive a communication request from the device 112 and/or a network node, as explained above with reference to FIG. 5. The bidding server 114 can use the communication request to generate and format proposal requests. For example, using the example of a dialed phone number, the bidding server 114, or, more particularly an application stored and/or executed by the bidding server 114, can determine a destination number and the current location of the device 112. A proposal request, which can include these and other data can be formatted and sent to a proposed generator 116, as illustrated at block 604.

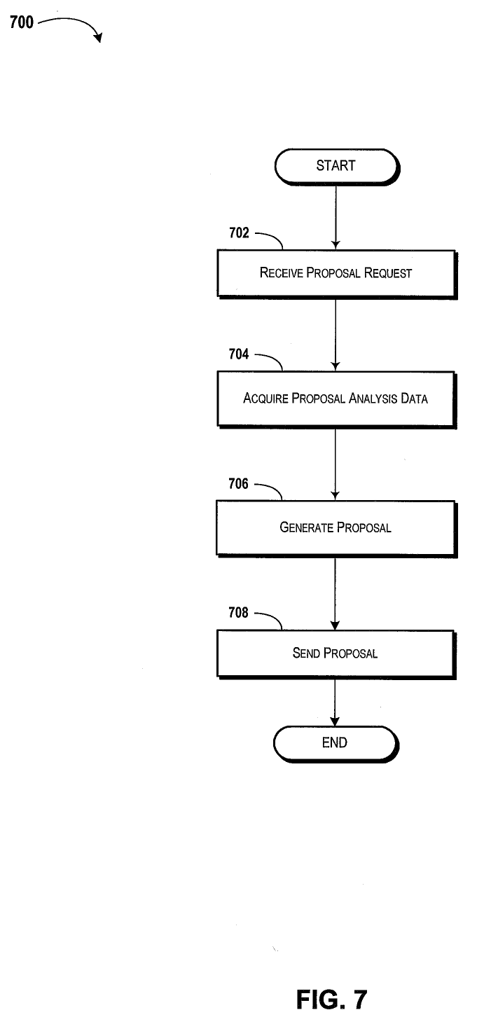

As will be explained with reference to FIG. 7, the proposal generators 116, 118, 120 can receive the proposal requests, generate a proposal, format the proposal information, and send the proposal to the bidding server 114. As illustrated at block 606, the bidding server 114 can receive the proposals. The proposals can be formatted, if desired, and the proposals can be sent to the device 112, as illustrated at block 608. The method 600 can end.

FIG. 7 schematically illustrates a method 700 for generating a proposal, according to an exemplary embodiment of the present disclosure. It should be understood that the steps described are not necessarily presented in any particular order and performance of some or all the steps in an alternative order(s) is possible and is contemplated. The steps have been presented in the demonstrated order for ease of description and illustration. Steps can be added, omitted and/or performed simultaneously without departing from the scope of the appended claims. Some or all steps of this process, and/or substantially equivalent steps, can be performed by execution of computer-readable instructions included on a computer readable medium.

The method 700 begins, and flow proceeds to block 702, wherein a proposal request is received, for example, by the proposal generator 116. The proposal requests can include data that indicates a requested voice and/or data resource, the origin location and/or network of a voice and/or data communication, a requested data transfer rate, a requested QoS, combinations thereof, and the like. Although not illustrated in FIG. 7, the proposal generator 116 can format the proposal requests into requests for network nodes. For example, if the proposal requests includes a telephone number, the proposal generator 116 can format a portion of the proposal request into a destination number, a network status request, voice call rate requests, and the like. Similarly, if the requested resource involves data transfer, the proposal generator 116 can format a network utilization status request, or the like, to determine current network status and/or rates.

As illustrated at block 704, the proposal generator 116 can acquire data needed to generate the requested proposal. For example, in some embodiments, proposal generation rules are created and stored at the proposal generator 116 by a network operator, a user, or another authorized entity. The rules can include network and user preferences and handling rules that define how certain communications are handled, rates that apply to the communications, promotions for certain communications, and the like. As such, the word “rules,” for purposes of the description and the claims, includes handling rules, preferences, rates, schedules, fees, promotions, network conditions, roaming agreements, subscription information, and the like, for determining a rate and/or a charge for a requested communication. Again, as mentioned above, the charge can be zero ($0.00) for some services. The rules can be updated in real-time, near-real-time, at designated intervals or schedules, upon updating, upon request, and/or by an authorized party at any time.

The determined rules can be applied to the proposal request. For example, if a defined rule provides that communications between 9:00 PM and 6:00 AM are entitled to a 20% discount, the proposal generator can determine if the requested communication is occurring between 9:00 PM and 6:00 AM. If so, the proposal generator 116 can determine that a 20% discount will apply to the rates and provide the discounted rate as part of a proposal. Similarly, certain nodes and/or communication routes can include surcharges and/or discounts due to time of day, repair schedules, network utilization, resource availability, and the like. Additionally, or alternatively, carriers use promotions to discount or surcharge services based upon historical usage information, roaming agreements, and the like. It will be appreciated that promotions or other real-time information can be used to allow network operators to communicate a willingness to offer a lower rate than usual to users that the network operators may otherwise be unable to reach.

In some embodiments, the proposal generator 116 communicates with one or more nodes of a network instead of, or in addition to, storing rules. The proposal generator 116 can communicate with the network nodes to determine network utilization, rate information, response times, and the like.

As illustrated at block 706, the proposal generator 116 can generate a proposal based upon the determined and applied rules, as well as by receiving data from one or more network nodes, as explained above. Although not illustrated in FIG. 7, the proposal generator 116 can format proposal information, if desired. As illustrated at block 708, the generated proposal can be transferred to the requesting entity, for example, the bidding server 114. The method 700 can end.

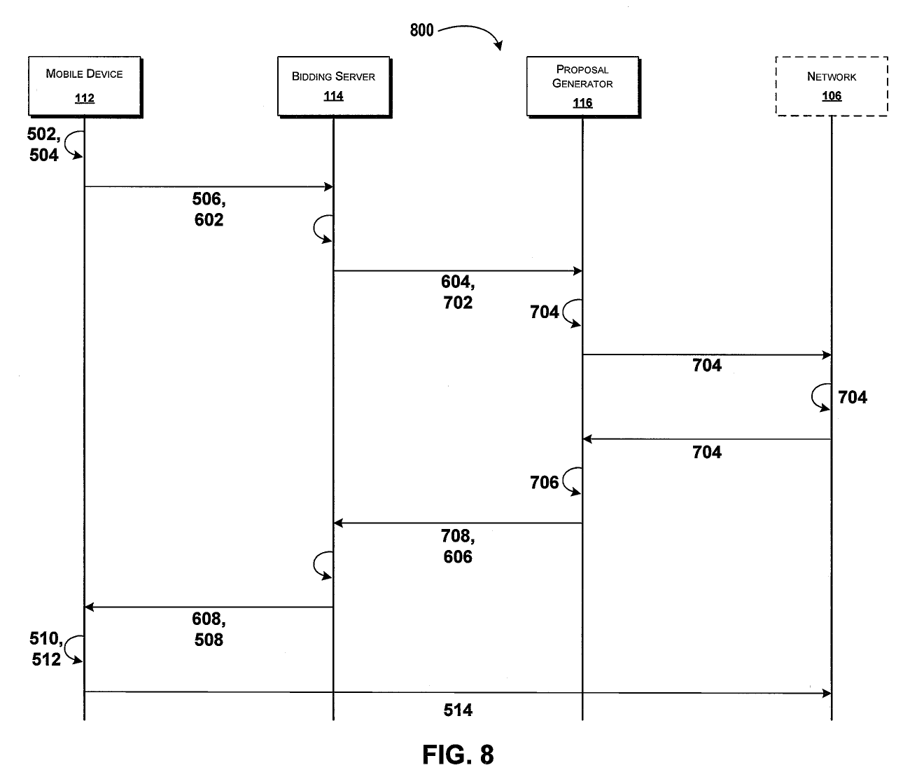

FIG. 8 is a flow diagram of an exemplary method 800 for providing carrier selection on display capable devices, according to an exemplary embodiment of the present disclosure. It will be appreciated that the method 800 illustrated in FIG. 8 includes many of the steps described above with reference to FIGS. 5-7. It should be understood that the steps described are not necessarily presented in any particular order and performance of some or all the steps in an alternative order(s) is possible and is contemplated. The steps have been presented in the demonstrated order for ease of description and illustration. Steps can be added, omitted and/or performed simultaneously without departing from the scope of the appended claims. Some or all steps of this process, and/or substantially equivalent steps, can be performed by execution of computer-readable instructions included on a computer readable medium.

As mentioned above, the proposal generator 116 can be omitted in some embodiments, and some or all of the functionality thereof can be performed by the bidding server 114, the network 106, or another entity, if desired. Therefore, it should also be understood that the bidding server 114 and the proposal generator 116 can be software and/or hardware modules operating on one or more nodes of a communications network 102.

As the steps illustrated in FIG. 8 have been described in more detail above, FIG. 8 will be described briefly to provide an overview of how a system 100 functions in an exemplary embodiment. As illustrated at steps 502, 504, a connection request can be received and analyzed at a device 112 to determine if a chargeable event is requested. As mentioned above, recognition of a chargeable event can occur at a network node such as, for example, the bidding server 114, instead of, or in addition to, the device 112. If a chargeable event is recognized, the connection request can be sent to, and received by, the bidding server 114, as illustrated at steps 506 and 602, respectively. Although not illustrated, the bidding server 114 can acquire data for analyzing a connection request and generating a proposal or bid. The bidding server 114 can contact one or more networks or network entities to use network rules, information, and status to generate the requested proposals.

In some embodiments, as illustrated at steps 604 and 702, the bidding server 114 can send one or more proposal requests to one or more proposal generators 116. In some embodiments, the proposal generator 116 stores proposal analysis data for evaluating proposal requests. In some embodiments, the proposal analysis data stored at the proposal generator 116 is not supplemented to generate a proposal. In some embodiments, the proposal analysis data stored at the proposal generator 116 is supplemented, for example, by real-time network information that is retrieved and/or shared on demand. In some embodiments, one or more network elements store and/or generate proposal analysis data to be used alone, or in conjunction with proposal analysis data stored at the proposal generator 116. The network elements can pass the proposal analysis data to the proposal generator 116. Each of these embodiments for acquiring proposal analysis data are illustrated at the steps 704.

The proposal generator 116 can use the proposal analysis data to generate a proposal, as illustrated at step 706. The proposals can be passed to, and received by, the bidding server 114, as illustrated by steps 708 and 606, respectively. The proposals can be sent to, and received by, a device 112, as illustrated at steps 608 and 508, respectively. The proposals can be evaluated at the device 112 and a choice can be made, as illustrated at steps 510 and 512, respectively. The device 112 can connect to the requested service, as illustrated at step 514. The method 800 can end.

Although not numbered steps in FIG. 8, the method 800 can include various formatting and conversion steps, which are illustrated in FIG. 8 as unnumbered arrows. Formatting and conversion steps can be employed to allow various network elements and/or devices to communicate with each other.

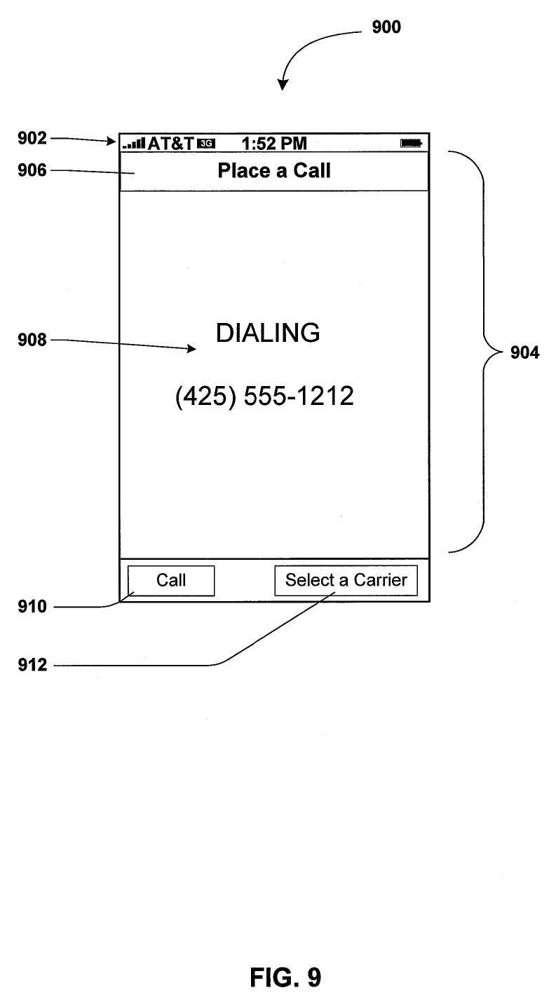

FIG. 9 illustrates an exemplary graphical user interface 900 (GUI) for a device 112, according to an exemplary embodiment of the present disclosure. The GUI 900 can be used to provide a device 112 with a dialing application that includes carrier selection functionality. In some embodiments, the GUI 900 is displayed by a video output source on a display 200 of a device 112. As illustrated, the GUI 900 can include operational information 902 for the device 112. The operational information 902 can include network information, for example, a signal meter for displaying the measured strength of a network signal, and information relating to the network with which the device 112 is in communication. In the illustrated GUI 900, the device 112 is indicating maximum signal strength and that the device 112 is currently connected to the AT&T third generation (3G) network. This indication is exemplary only, and the GUI 900 can be used on devices operating on other networks, other protocols, other standards, and/or operated by other carriers. The operational information 902 also can include, for example, the time of day, GPS satellite information, a date, a message waiting indicator, a battery meter, a short range radio communications device indicator, an alarm indicator, other information, and the like.

The GUI 900 includes a dialing interface 904 for viewing dialing information. The dialing interface 904 can include a title portion 906 for indicating to a user the function currently being performed by the device 112. Although not illustrated, dialing can be accomplished by interfacing with an I/O interface 216 of the device 112, for example, a keypad, a touchscreen, a multi-touch screen, a voice activated dialing program, and the like. The dialing interface 904 can display a dialed number 908, if desired. Other information, such as, for example, a picture of a dialed party, contact information for the dialed party, city, state, and/or country information, combinations thereof, and the like, if desired.

The GUI 900 also can include various options, for example, an option 910 to call the dialed party, an option 912 to select a carrier for the dialed number, an option (not illustrated) to exit the dialing application, additional and/or alternative options (not illustrated), combinations thereof, and the like. If a user selects the option 910, the call can be handled according to one or more default procedures. For example, the call can be sent to a default carrier for immediate routing to the dialed number, thereby bypassing the bidding and proposal functionality described above with respect to FIGS. 5-8. In some embodiments, as described above, all communication requests are routed through a bidding server 114 to determine if the requested communication is a chargeable event. As such, selection of the option 910 can be followed by some or all of the bidding and proposal functionality described above in FIGS. 5-8. If a user selects the option 912, the communication can be routed to the bidding server 114. Selection of the option 912 can inform the device 112, the bidding server 114, and/or another node of the communications network 102, that the requested communication is a chargeable event for which proposals are requested, thereby prompting execution of some or all of the steps described above with reference to FIGS. 5-8. It should be understood that the illustrated options 910, 912 are exemplary only. Additional and/or alternative options are possible and contemplated. For example, the option 912 can be omitted in embodiments wherein every communication request passes through a bidding server 114, wherein the device 112 automatically sends chargeable events to a bidding server 114, wherein the device 112 displays the option 912 only when bidding is deemed necessary, and/or other contemplated embodiments.

As mentioned above, the device 112 can review voice and data communications to determine if the requested communication is a chargeable event. As such, it should again be understood that the example of a voice call is used merely for illustration, and is not intended to limit the scope of the claims in any way.

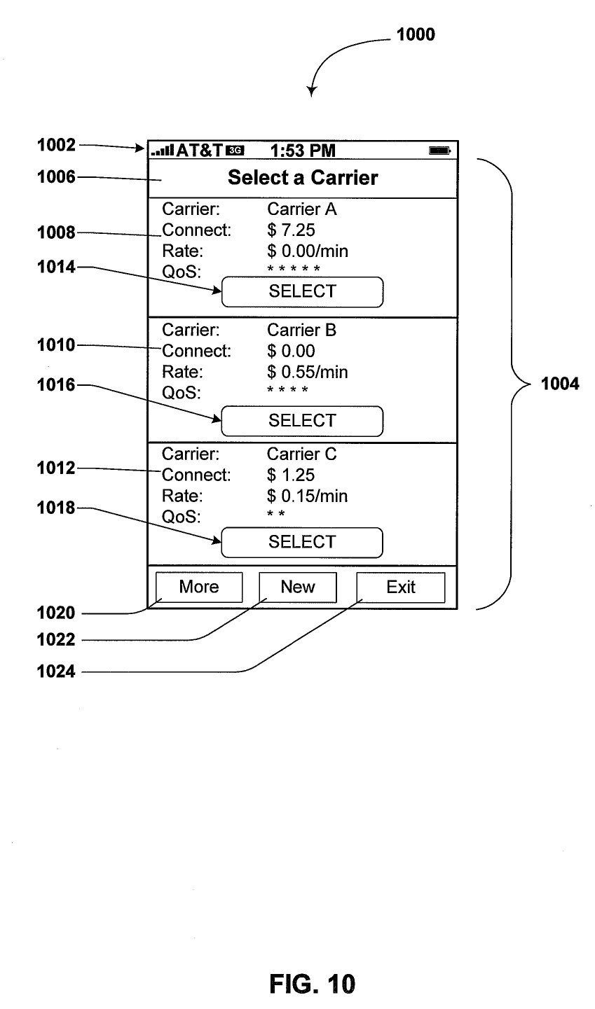

FIG. 10 illustrates a GUI 1000 for a device 112, according to another exemplary embodiment of the disclosure. The GUI 1000 can be used to provide a device 112 with an interface for selecting a carrier, e.g., via a UI for a carrier selection application. In some embodiments, the GUI 1000 is displayed by a video output source on a display 200 of a device 112. As illustrated, the GUI 1000 can include operational information 1002 for the device 112, as described above with reference to FIG. 9. The GUI 1000 can include a service selection interface 1004 for reviewing and selecting a service from one or more presented service options. The service selection interface 1004 can include a title portion 1006 for indicating to a user the function currently being performed by the device 112. In the illustrated embodiment, the title portion 1006 informs the user that the GUI 1000 is currently providing a carrier selection feature.

The service selection interface 1004 includes proposals 1008, 1010, 1012. The proposals 1008, 1010, 1012 can include various information relating to proposals. In the illustrated embodiment, the proposals 1008, 1010, 1012 include a carrier, a connection fee, a rate, and a guaranteed QoS. Although not illustrated, the proposals 1008, 1010, 1012 can also include a service information and/or terms, a communication time limit, time of day restrictions, service and/or carrier reviews, combinations thereof, and the like. The proposals 1008, 1010, 1012 can also include options 1014, 1016, 1018 to select a respective proposal 1008, 1010, 1012.

The GUI 1000 also can include various options, for example, an option 1020 to display more proposals, an option 1022 to generate a new communication request, an option 1024 to exit the service selection interface 1004, an option (not illustrated) to return to the dialing application, additional and/or alternative options (not illustrated), combinations thereof, and the like. It should be understood that the illustrated options 1020, 1022, 1024 are exemplary only. Additional and/or alternative options are possible and contemplated.

It should be understood that the illustrated rates, fees, and QoS ratings are exemplary only, and can be expressed in any desired terms and/or units. QoS can include one or more aspects of performance. For example, QoS, can include measures of available bandwidth, police rates, queue limits, random detects, dropped packets per second, response times, utilization percentages, combinations thereof, and the like. As such, QoS can be measured in any desired units including, but not limited to, bits per second (bps), kilobits per second (kbps), megabits per second (Mbps), kilobytes per second (kBps), packets, packets per second, milliseconds (ms), seconds (s), percentages, combinations thereof, and the like.

QoS can also include measures of overall communication quality, and can be based upon established standards, subjective quality ratings, combinations of various quality metrics, combinations thereof, and the like. As such, QoS can be represented as, for example, numbers of stars, a scale from 1-10, a scale from F to A, other letter and number scales, combinations thereof, and the like. In the illustrated embodiment of FIG. 10, QoS is measured in a number of asterisks from none to five, wherein five asterisks (* * * * *) is the highest rating available, and no asterisks is the lowest rating available. This QoS measure is exemplary only, and is included for purposes of clarifying the concepts of the present disclosure, and not to limit the scope of the appended claims.

In some contemplated embodiments, the bidding server 114 stores and applies a number of rules to allow the bidding server to avoid further communicating with a network operator. In other words, substantially all of the functionality of the proposal generator 116 can be performed by the bidding server 114. Additionally, or alternatively, the bidding server 114 can connect to a network node and determine rate information based upon network utilization, destination information, originating information, and the like. The illustrated embodiments include a proposal generator 116 for ease of description, but the proposal generator 116 functions can be performed by the bidding server 114, by a node on a network, or elsewhere on the communications network 102, if desired.

The ability of the system 100 to determine real-time network utilization information can be used to tailor a rate that meets network needs. For example, if a portion of a network is underutilized, a discount can be offered by the network operator to encourage selection of that network's service. Similarly, if a network, or a portion of a network, is overutilized, a network operator can add a surcharge to the proposal, to offset the high cost of providing the requested service. Similarly, if a network, or a portion of a network, is in need of repair, the network can factor the anticipated effect into a proposal, in terms of rates, QoS, response times, and the like, thereby increasing returns, improving customer service, and more accurately advertising its services, all of which can improve customer relations, and thereby, customer retention and revenues. Additionally, or alternatively, the network utilization can be used to make QoS guarantee decisions, namely, if a promised or requested QoS can be provided to the requesting user. As such, the system 100 can provide up-to-date quotes to requesting users that reflect real-time status of the network that is providing the proposal.

While the system 100 has been described as providing carrier selection functionality to a display capable device 112 operating on a cellular network 104, it should be understood that the systems and methods described herein can be embodied in other communications devices. In some embodiments, a communication-enabled computer is used as the device 112, and a call is made using voice over internet protocol (VoIP) technology over the Internet. It should be understood that VoIP calls can also make use of cellular and PSTN networks. In some embodiments, a wired telephone handset is used as the device 112, and a call is made using a PSTN. It should be understood that calls made with wired telephones can also make use of cellular and VoIP networks.

In some embodiments, the bidding server 114 includes interactive voice response (IVR) functionality. As such, devices that are not capable of displaying data can connect to the bidding server 114 via a voice connection, and can be presented with, and select, a carrier of choice via voice commands and/or dual-tone multi-frequency (DTMF) tones. It should be appreciated that including an IVR can allow support of legacy devices that are not capable of displaying large amounts of text, users with poor vision, users with poor reading ability, and/or users driving or performing other attention-intensive tasks, among others.

Although not described in detail above, the bidding server 114, the proposal generators 116, 118, 120, and/or other network nodes can track activity for purposes of paying royalties and/or commissions in multi-network arrangements. In one such contemplated arrangement, the bidding server 114 is operated by a first network operator, and the proposal generators 116, 118, 120 are operated by second, third, and fourth operators, respectively. If a user selects a service through a proposal obtained via the bidding server 114, the bidding server 114, the proposal generator 116, 118, 120, or another network node, can track the selection and pay a commission to the operator of the bidding server 114 as a commission for directing business to network associated with the selected service. It should be understood, however, that the bidding server 114 and one or more of the proposal generators 116, 118, 120 can be operated by the same entity.

In some embodiments, the bidding server 114 is operated by a neutral third party that confirms rules, network data, and/or QoS claims to ensure that proposals are fair and accurate. The neutral third party can, as explained above, track activity for billing, charging, and/or payment of royalties and/or commissions.

In some embodiments, the bidding server 114, the proposal generators 116, 118, 120, and/or other network nodes, can access one or more databases associated with one or more respective network operators, to obtain rules and/or network information for generating the proposals. As such, the proposal generators 116, 118, 120 and/or other network nodes can operate as databases that can be queried with information such as a destination number, a destination geographic area, an originating number, an originating geographic area, and the like. The retrieved information can be analyzed using the rules, the network status information, and the like, to generate the proposal, as explained above.

The law does not require and it is economically prohibitive to illustrate and teach every possible embodiment of the present claims. Hence, the above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A method for providing a proposal to a device operating on a communications network, comprising:
recognizing received data as a communication request received from the device, the communication request comprising data indicating a requested communication and a request for a proposal for providing the requested communication;
acquiring a proposal for the requested communication, the proposal comprising a charge for providing the requested communication and an indication of the network resource that will provide the requested communication; and
sending the proposal to the device.

2. The method of claim 1, wherein acquiring comprises:
sending a proposal request to a proposal generator; and
receiving a proposal from the proposal generator.

3. The method of claim 1, wherein acquiring the proposal comprises generating the proposal based, at least partially, upon analysis of the data indicating the requested communication using proposal analysis data.

4. The method of claim 3, wherein the generating the proposal comprises accessing a rule for determining the charge for the requested communication and for determining the network resource that will provide the requested communication.

5. The method of claim 3, wherein the generating the proposal comprises accessing network resource status information for determining the charge for the requested communication, for determining the network resource that will provide the requested communication, and for determining availability of the network resource.

6. The method of claim 3, wherein the generating the proposal comprises accessing network resource status information for determining the charge for the requested communication, for determining the network resource that will provide the requested communication, for determining availability of the network resource, and for determining a quality of service (QoS) for the communication.

7. The method of claim 6, wherein acquiring the proposal further comprises acquiring the proposal, the proposal further comprising a QoS for the communication.

8. The method of claim 6, wherein sending the proposal to the device comprises sending the proposal to a mobile communications device operating on a communications network.

9. The method of claim 6, wherein sending the proposal to the device comprises sending the proposal to a bidding server operating on a communications network.

10. The method of claim 6, wherein sending the proposal to the device comprises sending the proposal to a cellular telephone handset operating on a cellular communications network.

11. A method for generating a proposal for a requestor, comprising:
recognizing received data as a proposal request received from the requester, the proposal request comprising data indicating a requested communication and a request for a proposal for providing the requested communication;
acquiring proposal analysis data for analyzing the proposal request to determine a charge for the requested communication and to determine a network resource that will provide the requested communication;
generating a proposal for the requested communication, the proposal comprising the charge for providing the requested communication and an indication of the network resource that will provide the requested communication; and
sending the proposal to the requestor.

12. The method of claim 11, wherein acquiring the proposal analysis data comprises accessing a rule to determine the charge for the requested communication and to determine the network resource that will provide the requested communication.

13. The method of claim 11, wherein acquiring the proposal analysis data comprises accessing network resource status information to determine the charge for the requested communication, to determine the network resource that will provide the requested communication, and to determine availability of the network resource.

14. The method of claim 11, wherein sending the proposal to the requestor comprises sending the proposal to a mobile communications device operating on the first communications network.

15. The method of claim 11, wherein sending the proposal to the requester comprises sending the proposal to a bidding server operating on a second communications network.

16. The method of claim 11, wherein sending the proposal to the requestor comprises sending the proposal to a proposal generator operating on a third communications network.

17. The method of claim 11, wherein sending the proposal to the requester comprises sending the proposal to a cellular telephone handset operating on a cellular communications network.

18. A system for allowing a device operating on a communications network to select a network resource to use for a requested communication, the system comprising the device and a bidding server in communication with the device, wherein the device comprises:
a device memory in communication with a device processor and a device network interface, wherein the device memory is configured to store instructions, executable by the device processor to cause the device to:
request a proposal from the bidding server;
recognize received data as the proposal sent from the bidding server, the proposal comprising a charge for providing the requested communication and an indication of a network resource that will provide the requested communication;
select the proposal; and
connect to the network resource associated with the proposal via the network interface.

19. The system of claim 18, wherein the instructions for recognizing received data further comprise instructions, executable by the device processor to cause the device to recognize received data as two or more proposals sent from the bidding server, wherein each proposal comprises:
a charge for providing the requested communication; and
an indication of a network resource that will provide the requested communication.

20. The system of claim 18, further comprising a proposal generator for generating the proposal sent from the bidding server, the proposal generator comprising a generator processor in communication with a generator memory, wherein the generator memory is configured to store instructions, executable by the generator processor to cause the proposal generator to:
acquire proposal analysis data for analyzing the proposal request to determine the charge for the requested communication and to determine the network resource that will provide the requested communication;
generate the proposal for the requested communication, the proposal comprising the charge for providing the requested communication and an indication of the network resource that will provide the requested communication; and
send the proposal to the bidding server.

21. The system of claim 20, wherein the instructions stored in the generator memory for acquiring proposal analysis data further comprise instructions, executable by the generator processor to cause the proposal generator to:
acquire proposal analysis data comprising a rule for determining the charge for the requested communication and for determining the network resource that will provide the requested communication.

22. The system of claim 20, wherein the instructions stored in the generator memory for acquiring proposal analysis data further comprise instructions, executable by the generator processor to cause the proposal generator to:
acquire proposal analysis data comprising network resource status information for determining the charge for the requested communication, for determining the network resource that will provide the requested communication, and for determining availability of the network resource.

23. The system of claim 20, wherein the instructions stored in the generator memory for acquiring proposal analysis data further comprise instructions, executable by the generator processor to cause the proposal generator to:
acquire proposal analysis data comprising network resource status information for determining the charge for the requested communication, for determining the network resource that will provide the requested communication, for determining availability of the network resource, and for determining a quality of service (QoS) for the communication.

24. The system of claim 23, wherein recognizing received data as the proposal further comprises recognizing received data as the proposal, the proposal further comprising a QoS for the communication.

25. The system of claim 20, wherein acquiring proposal analysis data further comprises acquiring proposal analysis data comprising network resource status data that is acquired in real-time from a node of the communications network.
